(19) United States
(12) Patent Application Publication
(10) Pub. No.: US 2006/0105212 A1
(43) Pub. Date: May 18, 2006

(54) Fuel cell system

(76) Inventors: Seong-Jin An, Suwon-si (KR); Jong-Ki Lee, Suwon-si (KR); Jun-Won Suh, Suwon-si (KR); Sung-Yong Cho, Suwon-si (KR); Yeong-Chan Eun, Suwon-si (KR); Jan-Dee Kim, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/251,296

(22) Filed: Oct. 14, 2005

(30) Foreign Application Priority Data
Nov. 16, 2004 (KR) 10-2004-0093426

(51) Int. Cl. H01M 8/04; H01M 8/10; H01M 8/06

(52) U.S. Cl. 429/25; 429/23; 429/30; 429/20; 429/34

(57) ABSTRACT

A fuel cell system including: at least one electricity generator for generating electric energy through a reaction between fuel and oxygen and for discharging the remaining fuel; a fuel supply unit for supplying a predetermined amount of fuel to the electricity generator; an oxygen supply unit for supplying oxygen to the electricity generator; a valve unit which is connected to a fuel discharger of the electricity generator and which adjusts a fuel pressure in the electricity generator; a sensor unit which is disposed in the electricity generator and which senses an output amount of electricity of the electricity generator; and a control unit which converts a sensed signal from the sensor unit into a predetermined control signal and which controls the valve unit with the predetermined control signal.

### CROSS REFERENCE TO RELATED APPLICATION

This application claims priority to and the benefit of Korean Patent Application No. 10-2004-0093426, filed on Nov. 16, 2004, in the Korean Intellectual Property Office, the entire content of which is incorporated herein by reference.

### BACKGROUND OF THE INVENTION

1. Field of the Invention

The present invention relates to a fuel cell system and more particularly to a fuel cell system with a stack having an enhanced utilization rate of fuel.

2. Description of the Related Art

As is well known, a fuel cell is an electricity generating system which directly converts chemical reaction energy of independently supplied oxygen and hydrogen contained in hydrocarbon materials such as methanol, ethanol, or natural gas into electric energy.

A polymer electrolyte membrane fuel cell (hereinafter, referred to as PEMFC) has been recently developed to have an excellent output characteristic, a low operating temperature, and fast starting and response characteristics. Because of this, the PEMFC has a wide range of applications including mobile power sources for vehicles, distributed power sources for homes or other buildings, and small-size power sources for electronic apparatuses.

A fuel cell system employing the PEMFC scheme includes a fuel cell body or stack (hereinafter, referred to as stack for the purpose of convenience), a reformer for reforming fuel to generate hydrogen and for supplying the hydrogen to the stack, and an air pump or fan for supplying oxygen to the stack. The stack generates electric energy through an electrochemical reaction of the hydrogen supplied from the reformer and the oxygen supplied by the air pump or fan.

Alternatively, instead of the PEMFC scheme, the fuel cell system may employ a direct oxidation fuel cell scheme to supply fuel directly to the stack, and to generate electric energy through an electrochemical reaction of the fuel and oxygen. Unlike the fuel cell system employing the PEMFC scheme, the fuel cell system employing the direct oxidation fuel cell scheme does not require the reformer.

In a conventional fuel cell system, when the fuel used for the fuel cell, for example, hydrogen, is supplied to the stack, the stack generates electric energy through the electrochemical reaction of hydrogen and oxygen, and discharges the remaining hydrogen. The amount of remaining hydrogen discharged from the stack is about 20% or more of the predetermined amount of hydrogen supplied to the stack. Therefore, in the conventional fuel cell system, the utilization rate of fuel, that is, the percentage of the amount of hydrogen utilized for the reaction in the stack to the predetermined amount of hydrogen supplied to the stack, is less than 80%, thereby deteriorating the performance of the stack.

Also, in a conventional fuel cell system, since the entire fuel cell system is driven with the power generated from the stack, a parasitic power is generated for driving the entire fuel cell system.

As such, since the conventional fuel cell system includes an additional pump for supplying the fuel stored in the fuel tank to the stack or the reformer and this additional pump is driven by the parasitic power, the amount of the generated parasitic power is increased, thereby deteriorating the energy efficiency of the entire fuel cell system. In addition, since the conventional fuel cell system requires a space for providing the pump, it is difficult to make the entire fuel cell system compact.

### SUMMARY OF THE INVENTION

An embodiment of the present invention provides a fuel cell system with a stack having an improved utilization rate of fuel.

Another embodiment of the present invention provides a fuel cell system that reduces an amount of parasitic power and has a reduced size.

According to one embodiment of the present invention, there is provided a fuel cell system including: at least one electricity generator adapted to generate electric energy through a reaction between fuel and oxygen and adapted to discharge a remaining portion of the fuel, the electricity generator including a discharge part; and a pressure adjusting unit adapted to adjust fuel pressure in the electricity generator, the pressure adjusting unit including a valve unit, wherein the valve unit is connected to the fuel discharger of the electricity generator, and wherein the valve unit selectively opens and shuts the fuel discharger.

The valve unit may include a valve adapted to shut the fuel discharger to form a pressure atmosphere corresponding to a predetermined supply amount of fuel in the electricity generator and adapted to open the fuel discharger to purge the fuel in the electricity generator.

In the fuel cell system, a utilization rate of fuel may substantially vary in accordance with a fuel pressure in the electricity generator; a concentration of hydrogen in the fuel may substantially vary in accordance with the fuel pressure in the electricity generator; and an output amount of electricity of the electricity generator may substantially vary in accordance with the concentration of hydrogen in the fuel.

The pressure adjusting unit may include a sensor unit disposed in the electricity generator and adapted to sense the output amount of electricity. The pressure adjusting unit may also include a control unit adapted to control the valve unit in accordance with a data value corresponding to the output amount of electricity.

The fuel cell system may employ a polymer electrolyte membrane fuel cell scheme in which hydrogen gas is used as the fuel.

Alternatively, the fuel cell system may employ a direct oxidation fuel cell scheme in which liquid fuel is used as the fuel.

The oxygen may be obtained from air.

According to another embodiment of the present invention, there is provided a fuel cell system including: at least one electricity generator adapted to generate electric energy through a reaction between fuel and oxygen and adapted to discharge a remaining portion of the fuel, the electricity generator including a fuel discharger; a fuel supply unit adapted to supply a predetermined amount of fuel to the electricity generator; an oxygen supply unit adapted to supply oxygen to the electricity generator; a valve unit connected to the fuel discharger of the electricity generator and adapted to adjust a fuel pressure in the electricity generator; a sensor unit disposed in the electricity generator and adapted to sense an output amount of electricity of the electricity generator; and a control unit adapted to convert a sensed signal from the sensor unit into a predetermined control signal and adapted to control the valve unit with the predetermined control signal.

The electricity generator may include separators and a membrane-electrode assembly disposed between the separators. In this case, the electricity generator may include a plurality of electricity generators stacked adjacent to one another to form a stack.

The stack may include the fuel discharger, wherein the fuel discharger discharges the remaining portion of the fuel from the electricity generators. In this case, the valve unit may include a valve connected to the fuel discharger and which selectively opens and shuts the fuel discharger under control of the control unit.

The sensor unit may include a sensor which is disposed in at least one of the separators and senses a voltage value and/or a current value output from the electricity generator.

The control unit may include a microcomputer adapted to control the entire fuel cell system including an opening and shutting operation of the valve unit in accordance with the sensed signal of the sensor unit.

A pipe-shaped discharge line may be connected to the fuel discharger. In this case, the valve unit may include a valve disposed in the discharge line and which selectively opens and shuts the fuel discharger under control of the control unit.

The fuel supply unit may include a fuel tank adapted to store the fuel and a fuel pump connected to the fuel tank and adapted to discharge the fuel stored in the fuel tank. In addition, the fuel supply unit may include a fuel processing unit connected to the fuel tank and the electricity generator, the fuel processing unit being adapted to generate hydrogen from the fuel and adapted to supply the hydrogen to the electricity generator. In this case, the fuel processing unit may include: a reformer connected to the fuel tank and adapted to generate hydrogen from the fuel through a chemical catalytic reaction using thermal energy; and at least one carbon monoxide cleaner connected to the reformer and adapted to reduce a concentration of carbon monoxide contained in the hydrogen.

The fuel cell system may further include a valve disposed in a fuel supply path connecting the fuel tank to the reformer and adapted to selectively open and shut the fuel supply path. In this case, the valve may adjust the flow rate of fuel supplied to the reformer from the fuel tank under control of the control unit.

The oxygen supply unit may include at least one air pump adapted to pump air and to supply the air to the electricity generator.

According to another embodiment of the present invention, there is provided a fuel cell system including: at least one electricity generator adapted to generate electric energy through a reaction between fuel and oxygen and adapted to discharge a remaining fuel portion of the fuel, the electricity generator including a fuel discharger; a fuel processing unit adapted to generate hydrogen from the fuel and adapted to supply the hydrogen to the electricity generator; a fuel supply unit adapted to supply a predetermined amount of fuel to the fuel processing unit; an oxygen supply unit adapted to supply oxygen to the electricity generator; a valve unit connected to the fuel discharger of the electricity generator and adapted to adjust a fuel pressure in the electricity generator; a sensor unit disposed in the electricity generator and adapted to sense an output amount of electricity of the electricity generator; and a control unit adapted to convert a sensed signal from the sensor unit into a predetermined control signal and adapted to control the valve unit with the predetermined control signal.

The fuel supply unit may include a cylinder part forming a closed space and a fuel storage part disposed in the cylinder part.

The fuel storage part may have a flexible shape structure.

The fuel supply unit may include a bias part connected to the cylinder part and adapted to supply a compressed gas to the cylinder part to substantially compress the fuel storage part. In this case, the bias part may include a compressed gas supply member adapted to inject the compressed gas into the cylinder part.

The fuel supply unit may include a bias part connected to the cylinder part and the fuel storage part and which compresses the fuel storage part with a predetermined elastic force. In this case, the bias part may include an elastic member disposed in the cylinder part and connected to the fuel storage part.

The fuel cell system may further include a valve disposed in a fuel supply path connecting the fuel supply unit to the fuel processing unit and adapted to selectively open and shut the fuel supply path.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram schematically illustrating an entire construction of a fuel cell system according to a first embodiment of the present invention;

FIG. 2 is an exploded perspective view illustrating a structure of a stack shown in FIG. 1;

FIG. 3 is a block diagram schematically illustrating an entire construction of a fuel cell system according to a second embodiment of the present invention;

FIG. 4 is a perspective view illustrating an example of a fuel supply unit shown in FIG. 3;

FIG. 5 is a cross-sectional view of the fuel supply unit shown in FIG. 4;

FIG. 6 is a cross-sectional view illustrating a modified example of a fuel supply unit according to the second embodiment of the present invention;

FIG. 7 is a cross-sectional view illustrating an example of a fuel supply unit according to a third embodiment of the present invention;

FIG. 8 is a cross-sectional view illustrating a modified example of a fuel supply unit according to the third embodiment of the present invention; and

FIG. 9 is a block diagram schematically illustrating an entire construction of a fuel cell system according to a fourth embodiment of the present invention.

### DETAILED DESCRIPTION

In the following detailed description, certain embodiments of the present invention are shown and described, by way of illustration. As those skilled in the art would recognize, the described embodiments may be modified in various ways, all without departing from the spirit or scope of the present invention. Accordingly, the drawings and description are to be regarded as illustrative in nature, rather than restrictive.

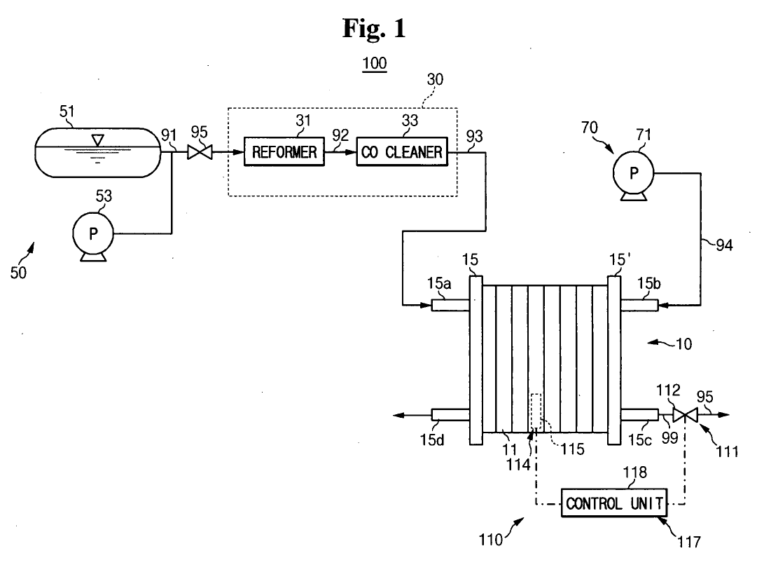

FIG. 1 is a block diagram schematically illustrating an entire construction of a fuel cell system 100 according to a first embodiment of the present invention.

Referring to FIG. 1, the fuel cell system 100 has a polymer electrode membrane fuel cell (PEMFC) scheme, which reforms fuel to generate hydrogen and allows hydrogen and oxygen to electrochemically react with each other to generate electric energy.

The fuel used in the fuel cell system 100 may include liquid fuel or gas fuel containing hydrogen such as methanol, ethanol, and natural gas. However, the liquid fuel is exemplified in the present embodiment for the purpose of convenience.

The fuel cell system 100 may utilize pure oxygen stored in an additional storage device as the necessary oxygen for reacting with the hydrogen or may utilize oxygen contained in air as the necessary oxygen. However, the latter is exemplified in the following description.

The fuel cell system 100 includes a stack 10 for generating electric energy through a reaction between hydrogen and oxygen, a fuel processing unit 30 for generating hydrogen from fuel and for supplying the fuel to the stack 10, a fuel supply unit 50 for supplying the fuel to the fuel processing unit 30, and an oxygen supply unit 70 for supplying oxygen to the stack 10.

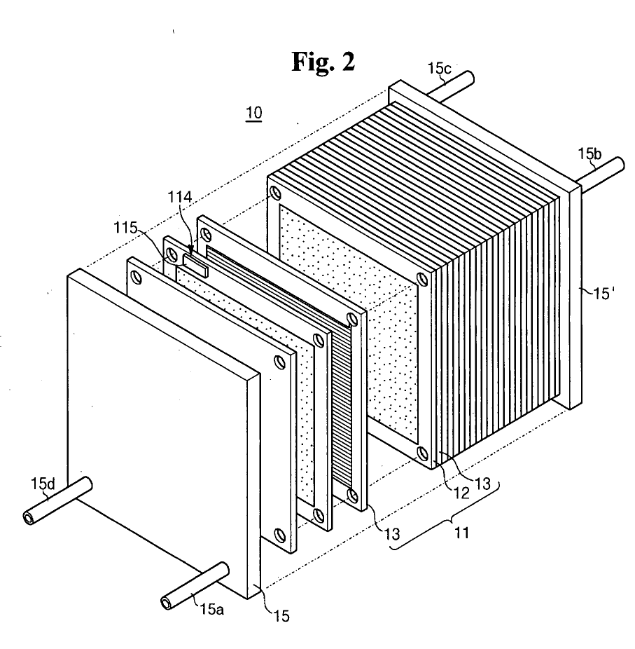

The stack 10 has an electricity generator (or a unit cell) 11 which is connected to the fuel processing unit 30 and the oxygen supply unit 70, is supplied with hydrogen from the fuel processing unit 30, and is supplied with air from the oxygen supply unit 70. The electricity generator 11 generates electric energy through the electrochemical reaction of the hydrogen and the oxygen. The specific structure of the stack 10 will be described in more detail below with reference to FIG. 2.

The fuel processing unit 30 (also referred to as fuel processor) includes a reformer 31 for generating a hydrogen-rich gas from the fuel through a reforming reaction using thermal energy and a carbon monoxide cleaner 33 for reducing the concentration of carbon monoxide contained in the hydrogen-rich gas. The reformer 31 generates the hydrogen-rich gas (hereinafter, referred to as hydrogen for the purpose of convenience) containing hydrogen, carbon dioxide, carbon monoxide, and the like from the fuel through a catalytic reaction such as a steam reforming reaction, a partial oxidation reaction, or an auto-thermal reaction. The carbon monoxide cleaner 33 reduces the concentration of carbon monoxide contained in the hydrogen by using a catalytic reaction such as a water-gas shift reaction and a preferential CO oxidation reaction or a hydrogen purification method with a separation membrane. The fuel processing unit 30 can include any suitable reformer 31 and any suitable carbon monoxide cleaner 33 employed in the fuel cell system having the PEMFC scheme and known to those skilled in the art.

The fuel supply unit 50 for supplying the fuel to the fuel processing unit 30 includes a fuel tank 51 for storing the fuel and a fuel pump 53 which is connected to the fuel tank 51 and which discharges the fuel from the fuel tank 51. The oxygen supply unit 70 includes an air pump 71 for pumping air with a predetermined pumping power and for supplying the air to the stack 10. The oxygen supply unit 70 is not limited to the air pump 71, but may include a conventional fan.

FIG. 2 is an exploded perspective view illustrating the stack 10 shown in FIG. 1. The stack 10 according to the present embodiment has an electricity generator 11 in which separators (also referred to as bipolar plates) 13 are disposed on both surfaces of a membrane-electrode assembly (hereinafter, referred to as MEA) 12. In the present embodiment, a plurality of electricity generators 11 are stacked adjacent to one another to form the stack 10.

The MEA 12 disposed between the separators 13 includes an anode electrode formed on one surface, a cathode electrode formed on another surface, and an electrolyte membrane formed between both the anode and cathode electrodes. The anode electrode decomposes hydrogen into hydrogen ions and electrons. The electrolyte membrane moves hydrogen ions to the cathode electrode. The cathode electrode generates moisture through a reaction of the electrons and hydrogen ions moved from the anode electrode and oxygen in the air.

The separators 13 disposed adjacent to both surfaces of the MEA 12 function as a conductor for connecting the anode electrode and the cathode electrode of the MEA 12 in series to each other, and also function to supply the hydrogen gas supplied from the fuel processing unit 30 to the anode electrode of the MEA 12 and to supply the air supplied by the air pump 71 to the cathode electrode.

The outermost sides of the stack 10 may be provided with additional pressing plates 15 and 15′ for bringing a plurality of electricity generators 11 into close contact with each other. The stack 10 according to the present invention may be constructed such that the separators 13 located at the outermost sides of the plurality of electricity generators 11 carry out the function as the pressing plates, instead of the pressing plates 15 and 15′.

The pressing plates 15 and 15′ are provided with a first injection hole 15a for supplying the hydrogen to the electricity generators 11, a second injection hole 15b for supplying the air to the electricity generators 11, a first discharge hole 15c for discharging the remaining hydrogen from the electricity generators 11, and a second discharge hole 15d for discharging the moisture generated through the bonding reaction of hydrogen and oxygen and the remaining air from the electricity generators 11. A pipe-shaped discharge line 99 for discharging the remaining hydrogen from the stack 10 is connected to the first discharge hole 15c as shown in FIG. 1.

In the fuel cell system 100 according to the present invention, the elements are connected through pipe-shaped flow channels. That is, the fuel tank 51 and the reformer 31 are connected through a first supply line 91, the reformer 31 and the carbon monoxide cleaner 33 are connected through a second supply line 92, the carbon monoxide cleaner 33 and the first injection hole 15a of the stack 10 are connected through a third supply line 93, and the air pump 71 and the second injection hole 15b of the stack 10 are connected through a fourth supply line 94.

The first supply line 91 is provided with a first valve 95 for selectively opening and shutting the first supply line 91 under control of the control unit 117 described below. The first valve 95 has a known flow rate adjusting valve, for example, a throttle valve, for adjusting the amount of fuel discharged from the fuel tank 51 with the pumping power of the fuel pump 53 and supplying a predetermined amount of fuel to the fuel processing unit 30. The first valve 95 can be embodied as any suitable throttle valve known to those skilled in the art.

In the present invention, since the predetermined amount of fuel can be supplied to the fuel processing unit 30, the fuel processing unit 30 can generate a predetermined amount of hydrogen from the fuel and supply the hydrogen to the electricity generators 11.

The predetermined amount of fuel is referred to as an amount of fuel that the fuel processing unit 30 can use to generate an amount of hydrogen to produce a predetermined output amount of electricity of the stack 10. That is, the predetermined amount of fuel is referred to as the amount of fuel supplied to the fuel processing unit 30 through the first supply line 91 for a predetermined time in consideration of the pumping pressure of the fuel pump 53 and the pipe diameter of the first supply line 91 when the first supply line 91 is opened by the first valve 95. Since the amount of fuel can be varied in accordance with the pumping pressure of the fuel pump 53, the pipe diameter of the first supply line 91, and the driving time of the fuel pump 53, the amount of fuel is not limited to any specified value.

In the fuel cell system 100 according to the present invention having the above-mentioned structure, the stack 10 discharges the remaining hydrogen from the electricity generators 11 through a fuel discharger, e.g., the first discharge hole 15c. The remaining hydrogen corresponds to about 20% of the predetermined amount of hydrogen supplied to the stack 10 from the fuel processing unit 30. Ideally, the utilization rate of fuel in the stack 10 should be close to 100%. However, in actuality, the utilization rate of fuel is less than 80%, thereby deteriorating the performance of the stack 10.

The utilization rate of fuel λ indicates a ratio of the amount of hydrogen reacting with oxygen to the predetermined amount of hydrogen supplied to the electricity generators 11 of the stack 10 from the fuel processing unit 30. That is, the utilization rate of fuel λ is referred to as a percentage value of the amount of hydrogen Q2 substantially reacting with oxygen in the electricity generators 11 to the predetermined amount of hydrogen Q1 supplied to the electricity generators 11 from the fuel processing unit 30. The utilization rate of fuel can be expressed by the following equation.
λ=Q2/Q1×100

The fuel cell system 100 according to the present embodiment includes a pressure adjusting unit 110 for adjusting hydrogen pressure in the electricity generators 11 of the stack 10 and substantially enhancing the utilization rate λ of the stack 10.

The pressure adjusting unit 110 selectively opens and shuts the first discharge hole 15c of the stack and thus adjusts the fuel pressure, that is, the hydrogen pressure, in the electricity generators 11.

Specifically, the pressure adjusting unit 110 includes a valve unit 111 connected to the first discharge hole 15c of the stack 10, a sensor unit 114 which is connected to the electricity generators 11 and which senses the output amount of electricity of the electricity generators 11, and a control unit 117 which converts the sensed signal of the sensor unit 114 into a predetermined control signal and controls the valve unit 111 with the control signal.

The valve unit 111 is composed of a second valve 112 disposed in the above-mentioned discharge line 99. The second valve 112 has a solenoid valve which selectively opens and shuts the discharge line 99, that is, opens and shuts the first discharge hole 15c of the stack under the control of the control unit 117. The second valve 112 forms the hydrogen pressure corresponding to the predetermined amount of hydrogen in the electricity generators 11 by shutting the first discharge hole 15c of the stack 10. The second valve 112 externally discharges the hydrogen in the electricity generators 11 by opening the first discharge hole 15c of the stack 10. The second valve 112 can be embodied as any suitable solenoid valve known to those skilled in the art.

When the second valve 112 shuts the first discharge hole 15c, the hydrogen stays in the electricity generators 11, the hydrogen pressure is increased, and thus the concentration of hydrogen is increased. The increase in concentration of hydrogen increases the utilization rate of fuel λ described above.

The sensor unit 114 includes a suitable electricity detection sensor 115 which is disposed in the separator 13 of the electricity generators 11 and which detects the output amount of electricity generated from the electricity generators 11, that is, a current value and/or a voltage value. In one embodiment, the electricity detection sensor 115 may be disposed in the separator 13 of one of the plurality of electricity generators 11.

The control unit 117 is a controller for controlling the entire driving of the fuel cell system 100. In the present embodiment, the control unit 117 is embodied as a suitable microcomputer 118 connected to the first and second valves 95 and 112 and the electricity detection sensor 115. The microcomputer 118 controls the first valve 95 to adjust the amount of fuel supplied to the reformer 31 from the fuel tank 51. In addition, the microcomputer 118 converts a signal sensed by the electricity detection sensor 115 into a control signal and controls the opening and shutting operation of the second valve 112 with the control signal.

Specifically, the microcomputer 118 converts the sensed signal from the electricity detection sensor 115 into a control signal, reads out the control signal, and compares the output amount of electricity (hereinafter, referred to as sensed data value) sensed by the electricity detection sensor 115 with the output amount of electricity in a predetermined allowable range (hereinafter, referred to as reference data value). When the sensed data value is greater than the reference data value, the microcomputer 118 controls the second valve 112 to shut the first discharge hole 15c of the stack 10. In contrast, when the sensed data value is less than the reference data value, the microcomputer 118 controls the second valve 112 to open the first discharge hole 15c.

The predetermined allowable range of the output amount of electricity indicates 80% or more of the intrinsic output amount of electricity of the electricity generators 11 which can vary according to the specification of the fuel cell system 100.

Operations of the fuel cell system according to the first embodiment of the present invention are now described in more detail below.

First, at the time of starting up the fuel cell system 100, the microcomputer 118 controls the second valve 112 to shut the first discharge hole 15c of the stack 10.

Subsequently, the microcomputer 118 controls the first valve 95 to open the first supply line 91. At the same time, the fuel pump 53 discharges the fuel stored in the fuel tank 51 and supplies the fuel to the reformer 31 through the first supply line 91.

In the process, the microcomputer 118 controls the first valve 95 to open the first supply line 91 for a predetermined time. Accordingly, the fuel stored in the fuel tank 51 is supplied to the reformer 31 through the first supply line 91 with the pumping pressure of the fuel pump 53, where the amount of fuel supplied to the reformer 31 corresponds to the predetermined output amount of electricity of the stack 10.

Next, the reformer 31 generates a predetermined amount of hydrogen from the fuel through the reforming reaction using thermal energy. However, since it is difficult for the reformer 31 to completely carry out the reforming reaction, the reformer 31 generates hydrogen-rich gas containing a very small amount of carbon monoxide as a byproduct.

Subsequently, the reformer 31 supplies the hydrogen-rich gas to the carbon monoxide cleaner 33 through the second supply line 92. Then, the carbon monoxide cleaner 33 reduces the concentration of carbon monoxide contained in the hydrogen-rich gas and supplies the hydrogen-rich gas to the first injection hole 15a of the stack 10 through the third supply line 93. At the same time, the microcomputer 118 activates the air pump 71 to supply the air to the second injection hole 15b of the stack 10 through the fourth supply line 94.

Next, the microcomputer 118 controls the first valve 95 to shut the first supply line 91.

In the process, since the first discharge hole 15c of the stack 10 is kept shut with the second valve 112, the hydrogen pressure corresponding to the predetermined amount of hydrogen is formed in the electricity generators 11 of the stack 10 and thus the hydrogen pressure in the electricity generators 11 is increased.

In this way, when the hydrogen pressure in the electricity generators 11, that is, between the separators 13 and the anode electrodes of the MEA 12, is increased, the concentration of hydrogen is increased. The electricity generators 11 generate electric energy through the electrochemical reaction of the hydrogen and oxygen.

When the concentration of hydrogen in the electricity generators 11 is increased with respect to the predetermined amount of hydrogen supplied to the electricity generators 11 of the stack 10, the utilization rate of fuel k of the stack 10 is substantially increased. That is, since the amount of hydrogen consumed in the electricity generators 11 is increased with respect to the predetermined amount of hydrogen, the utilization rate of fuel λ of the stack 10 is naturally increased. Therefore, the stack 10 can accomplish the utilization rate of fuel X ranging from 80% to 100%. However, the concentration of hydrogen in the electricity generators 11 is gradually decreased with the lapse of time due to the reaction between hydrogen and oxygen. Accordingly, the output amount of electricity of the stack 10 is gradually decreased.

In the process, the electricity detection sensor 115 senses the output amount of electricity of the electricity generator 11, for example, a current value and/or a voltage value, and sends the sensed signal to the microcomputer 118. The microcomputer 118 converts the sensed signal into a control signal, reads out the control signal, and compares the output amount of electricity sensed by the electricity detection sensor 115 with the output amount of electricity in the predetermined allowable range, which is 80% or more of the intrinsic output amount of electricity of the electricity generators 11. When the output amount of electricity sensed by the electricity detection sensor 115 is less than the output amount of electricity in the predetermined allowable range, the microcomputer 118 controls the second valve 112 to open the first discharge hole 15c of the stack 10; otherwise the microcomputer 118 control the second valve 112 to shut the first discharge hole 15c.

When the first discharge hole 15c is opened, the hydrogen remaining in the electricity generators 11 of the stack 10 is discharged through the first discharge hole 15c. The purged gas discharged through the first discharge hole 15c contains only a very small amount of hydrogen, and the other hydrogen has been consumed by reacting with oxygen in the electricity generators 11.

Thereafter, the microcomputer 118 controls the first valve 95 to supply the predetermined amount of fuel to the fuel processing unit 30 again. Then, the fuel cell system 100 repeats the series of processes described above.

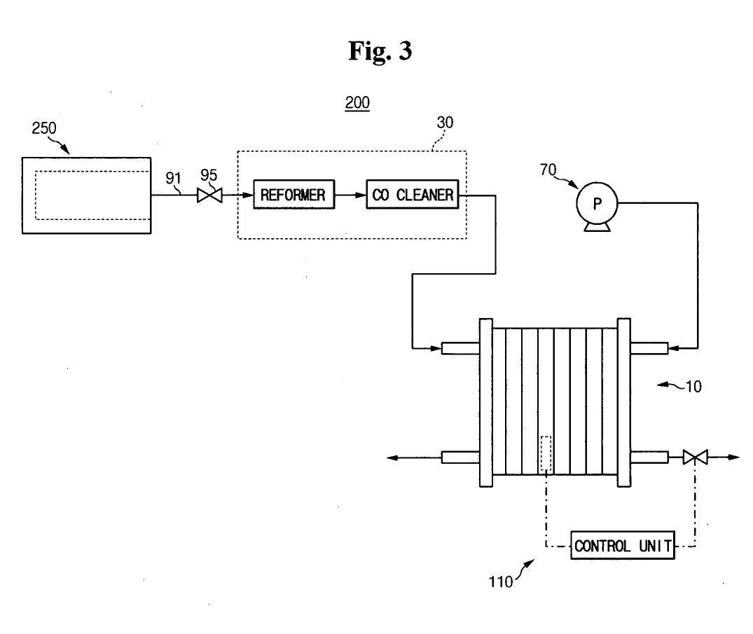

FIG. 3 is a block diagram schematically illustrating an entire construction of a fuel cell system 200 according to a second embodiment of the present invention. The elements denoted by the same reference numerals as in FIG. 1 are elements having the same functions.

Referring to FIG. 3, the fuel cell system 200 according to the present embodiment has substantially the same structure as in the first embodiment, except for a fuel supply unit 250 adapted to supply the fuel stored in an additional storage device to the fuel processing unit 30 with a compression force of compressed air.

The stack 10, the fuel processing unit 30, the oxygen supply unit, and the pressure adjusting unit 110 shown in FIG. 3 are substantially the same as those of the first embodiment and thus detailed descriptions thereof will not be provided again.

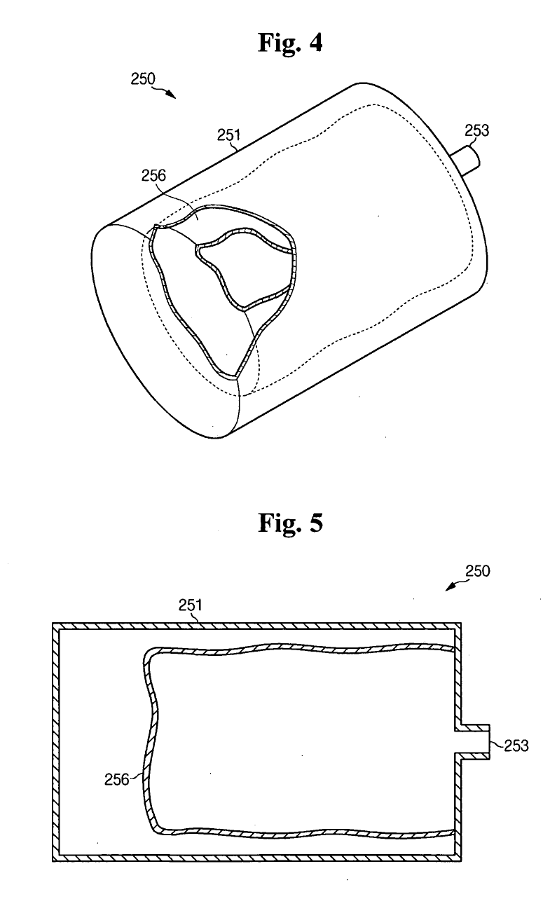

FIG. 4 is a perspective view illustrating an example of the fuel supply unit 250 shown in FIG. 3, and FIG. 5 is a cross-sectional view of the fuel supply unit 250 shown in FIG. 4. The fuel supply unit 250 according to the present embodiment includes a cylinder part 251 connected to the fuel processing unit 30 and a fuel storage part 256 which is disposed in the cylinder part 251 and which stores fuel.

The cylinder part 251 has a cylindrical closed vessel structure having a predetermined volume of closed space in which both ends are closed. A discharge part 253 connected to the fuel processing unit 30 through the first supply line 91 is formed at one end of the cylinder part 251.

In the present embodiment, the cylinder part 251 stores compressed gas in the closed space, such that a predetermined pressure of the compressed gas is formed in the closed space.

The fuel storage part 256 is disposed in the closed space of the cylinder part 251 and forms a storage space for storing the fuel. The fuel storage part 256 has a structure such that the storage space communicates with the discharge part 253 of the cylinder part 251. The fuel storage part 256 is made of a flexible material so that the storage space can be deformed by the compression force of the compressed gas stored in the cylinder part 251. That is, the fuel storage part 256 has a flexible envelope shape.

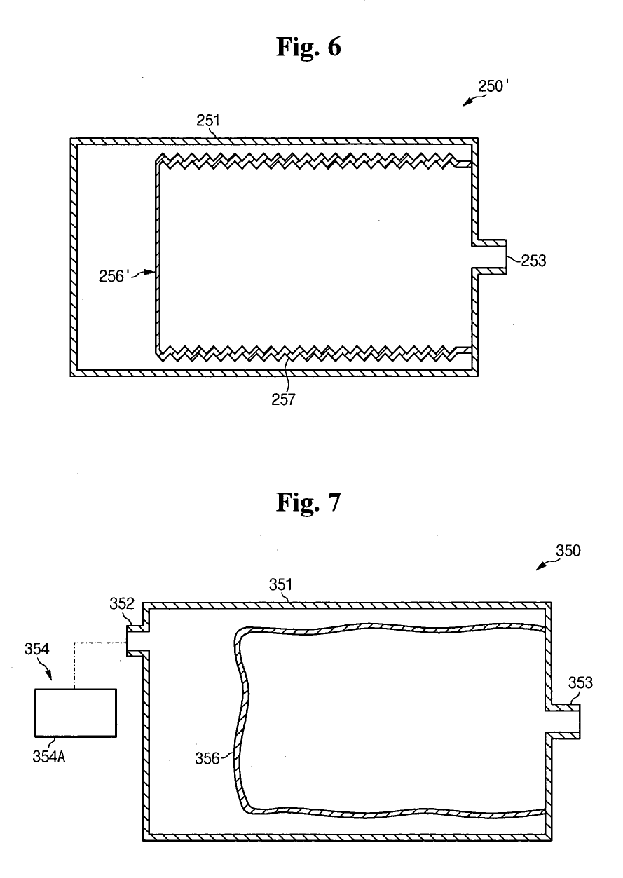

FIG. 6 shows a modified example of a fuel supply unit 250′ according to the second embodiment. The fuel supply unit according the modified example has substantially the same structure as the second embodiment, except that a bellows-shaped wrinkled portion 257 is formed in the main body of the fuel storage part 256′ so as to contract the main body with the compression force of the compressed gas.

Therefore, when the first valve 95 opens the first supply line 91, the fuel storage part 256′ is contracted with the compressed gas stored in the closed space of the cylinder part 251 (see FIG. 3).

Accordingly, the fuel stored in the fuel storage part 256′ is discharged through the discharge part 253 and is supplied to the fuel processing unit 30 through the first supply line 91 (see FIG. 3).

FIG. 7 is a cross-sectional view illustrating an example a fuel supply unit 350 according to a third embodiment of the present invention.

Referring to FIG. 7, the fuel supply unit 350 according to the present embodiment has substantially the same structure as in the second embodiment, except for a bias part 354 adapted to inject compressed gas into the closed space of the cylinder part 351 and to compress the fuel storage part 356 with the compression force of the compressed gas.

An injection part 352 communicating with the closed space is formed at one end of the cylinder part 351, and a discharge part 353 is formed at another end.

The bias part 354 according to the present embodiment is connected to the injection part 352 of the cylinder part 351 and injects the compressed gas into the closed space of the cylinder part 351. The bias part 354 can be embodied as a compressed gas supply member 354A for storing the compressed air.

Therefore, in a state where the compressed gas supply member 354A is connected to the injection part 352 of the cylinder part 351, the compressed gas stored in the compressed gas supply member 354A is injected into the closed space of the cylinder part 351 through the injection part 352. Then, the fuel storage part 356 is contracted with the compression pressure of the compressed gas acting on the closed space of the cylinder part 351. Accordingly, the fuel stored in the fuel storage part 356 is discharged through the discharge part 353 by contraction of the fuel storage part 356.

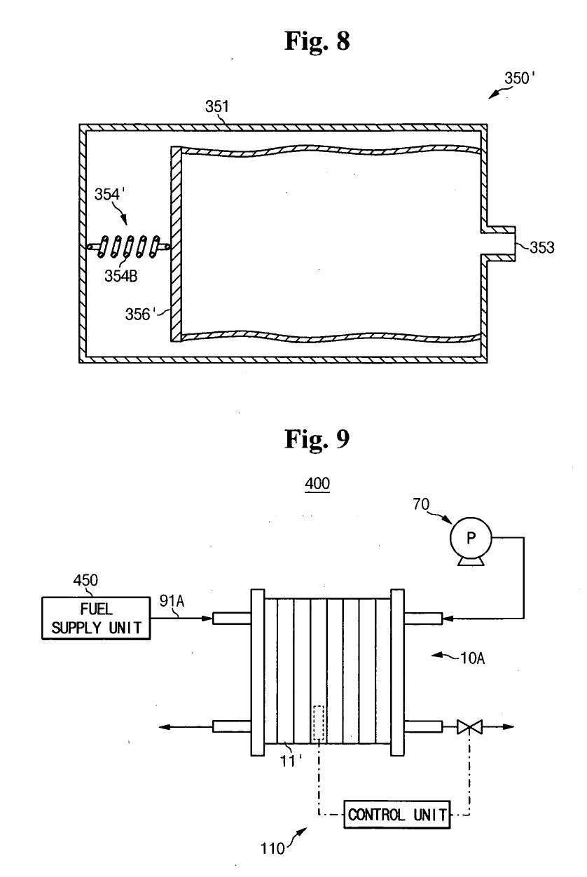

FIG. 8 is a cross-sectional view illustrating a modified example of a fuel supply unit 350′ according to the third embodiment of the present invention.

Referring to FIG. 8, the bias part 354′ has an elastic member 354B adapted to compress the fuel storage part 356′.

The elastic member 354B is disposed in the inner space of the cylinder part 351 and is connected to the fuel storage part 356′. In one embodiment, the elastic member 354B can be embodied as a compression spring having a predetermined elastic force. One end of the elastic member 354B is connected to the inner wall of the cylinder part 351, and the other end is connected to the main body of the fuel storage part 356′.

Therefore, when the elastic force of the elastic member 354B is applied to the fuel storage part 356′, the fuel storage part 356′ is contracted with the elastic force, and the fuel stored in the fuel storage part 356′ can be discharged through the discharge part 353 of the cylinder part 351.

FIG. 9 is a block diagram schematically illustrating an entire construction of a fuel cell system 400 according to a fourth embodiment of the present invention.

Referring to FIG. 9, the fuel cell system 400 according to the present embodiment employs a direct oxidation fuel cell scheme which directly supplies the liquid fuel such as methanol or ethanol to a stack 10A and generates electric energy through the reaction between the fuel and oxygen.

Unlike the fuel cell system having the PEMFC scheme, the fuel cell system 400 having the direct oxidation fuel cell scheme does not require the fuel processing unit 30 shown in FIG. 1. Instead, the fuel cell system 400 includes a fuel supply unit 450 which can supply the fuel stored in the fuel tank 51 directly to the electricity generators 11′ of the stack 10A with the fuel pump 53.

The fuel cell system 400 has a structure such that the fuel tank 51 (see FIG. 1) of the fuel supply unit 450 is connected to the stack 10A through a pipe-shaped flow channel 91A. Accordingly, the fuel supply unit 450 can supply the fuel directly to the electricity generators 11′ of the stack 10A.

Alternatively, the fuel supply unit 450 may be embodied with structures that are substantially the same as the structures of the embodiments of FIGS. 3, 4, 5, 6, 7, and/or 8; thus detailed descriptions thereof will not be provided again.

In FIG. 9, the oxygen supply unit 70 and the pressure adjusting unit 110 are substantially the same as those in the aforementioned embodiments. Therefore, detailed descriptions thereof will not be provided again.

According to embodiments of the present invention described above, the utilization rate of fuel of the entire stack can be enhanced by adjusting the hydrogen pressure in the electricity generators, thereby enhancing the performance of the fuel cell system.

According to embodiments of the present invention, the fuel stored in the fuel storage part can be supplied to the reformer or stack by deforming the fuel storage part with a predetermined compression force. Therefore, the parasitic power required for driving the entire system can be reduced, thereby further enhancing the energy efficiency of the fuel cell system. In addition, since the fuel pump is not required, it is possible to make the fuel cell system more compact.

While the invention has been described in connection with certain embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A fuel cell system comprising:
at least one electricity generator adapted to generate electric energy through a reaction between fuel and oxygen and adapted to discharge a remaining portion of the fuel, the electricity generator including a fuel discharger; and
a pressure adjusting unit adapted to adjust fuel pressure in the electricity generator, the pressure adjusting unit including a valve unit,
wherein the valve unit is connected to the fuel discharger of the electricity generator, and
wherein the valve unit selectively opens and shuts the fuel discharger.

2. The fuel cell system of claim 1, wherein the valve unit comprises a valve adapted to shut the fuel discharger to form a pressure atmosphere corresponding to a predetermined supply amount of fuel in the electricity generator and adapted to open the fuel discharger to purge the fuel in the electricity generator.

3. The fuel cell system of claim 1, wherein a utilization rate of fuel substantially varies in accordance with a fuel pressure in the electricity generator.

4. The fuel cell system of claim 3, wherein a concentration of hydrogen in the fuel substantially varies in accordance with the fuel pressure in the electricity generator.

5. The fuel cell system of claim 4, wherein an output amount of electricity of the electricity generator substantially varies in accordance with the concentration of hydrogen in the fuel.

6. The fuel cell system of claim 5, wherein the pressure adjusting unit comprises a sensor unit disposed in the electricity generator, wherein the sensor unit senses the output amount of electricity, and wherein the pressure adjusting unit also comprises a control unit adapted to control the valve unit in accordance with a data value corresponding to the output amount of electricity.

7. The fuel cell system of claim 1, wherein hydrogen gas is used as the fuel.

8. The fuel cell system of claim 1, wherein liquid fuel is used as the fuel.

9. The fuel cell system of claim 1, wherein the oxygen is obtained from air.

10. The fuel cell system of claim 7, wherein a polymer electrolyte membrane fuel cell scheme is employed.

11. The fuel cell system of claim 8, wherein a direct oxidation fuel cell scheme is used.

12. A fuel cell system comprising:
at least one electricity generator adapted to generate electric energy through a reaction between fuel and oxygen and adapted to discharge a remaining portion of the fuel, the electricity generator including a fuel discharger;
a fuel supply unit adapted to supply a predetermined amount of fuel to the electricity generator;
an oxygen supply unit adapted to supply oxygen to the electricity generator;
a valve unit connected to the fuel discharger of the electricity generator and adapted to adjust a fuel pressure in the electricity generator;
a sensor unit disposed in the electricity generator and adapted to sense an output amount of electricity of the electricity generator; and
a control unit adapted to convert a sensed signal from the sensor unit into a predetermined control signal and adapted to control the valve unit with the predetermined control signal.

13. The fuel cell system of claim 12, wherein the electricity generator comprises separators and a membrane-electrode assembly disposed between the separators.

14. The fuel cell system of claim 13, wherein the electricity generator comprises a plurality of electricity generators stacked adjacent to one another to form a stack.

15. The fuel cell system of claim 14, wherein the stack comprises the fuel discharger and wherein the fuel discharger discharges the remaining portion of the fuel from the electricity generators.

16. The fuel cell system of claim 15, wherein the valve unit comprises a valve connected to the fuel discharger and wherein the valve selectively opens and shuts the fuel discharger under control of the control unit.

17. The fuel cell system of claim 13, wherein the sensor unit comprises a sensor disposed in at least one of the separators and wherein the sensor senses a voltage value and/or a current value output from the electricity generator.

18. The fuel cell system of claim 13, wherein the control unit comprises a microcomputer adapted to control the entire fuel cell system including an opening and shutting operation of the valve unit in accordance with the sensed signal of the sensor unit.

19. The fuel cell system of claim 15, wherein a pipe-shaped discharge line is connected to the fuel discharger.

20. The fuel cell system of claim 19, wherein the valve unit comprises a valve disposed in the discharge line and wherein the valve selectively opens and shuts the fuel discharger under control of the control unit.

21. The fuel cell system of claim 12, wherein the fuel supply unit comprises a fuel tank adapted to store the fuel and a fuel pump connected to the fuel tank and wherein the fuel pump discharges the fuel stored in the fuel tank.

22. The fuel cell system of claim 21, wherein the fuel supply unit comprises a fuel processing unit connected to the fuel tank and the electricity generator, the fuel processing unit being adapted to generate hydrogen from the fuel and adapted to supply the hydrogen to the electricity generator.

23. The fuel cell system of claim 22, wherein the fuel processing unit comprises:
a reformer connected to the fuel tank and adapted to generate hydrogen from the fuel through a chemical catalytic reaction using thermal energy; and
at least one carbon monoxide cleaner connected to the reformer and adapted to reduce a concentration of carbon monoxide contained in the hydrogen.

24. The fuel cell system of claim 23, further comprising a valve disposed in a fuel supply path connecting the fuel tank to the reformer and adapted to selectively open and shut the fuel supply path.

25. The fuel cell system of claim 24, wherein the valve adjusts the flow rate of fuel supplied to the reformer from the fuel tank under control of the control unit.

26. The fuel cell system of claim 12, wherein the oxygen supply unit comprises at least one air pump adapted to pump air and adapted to supply the air to the electricity generator.

27. A fuel cell system comprising:
at least one electricity generator adapted to generate electric energy through a reaction between fuel and oxygen and adapted to discharge a remaining fuel portion of the fuel, the electricity generator including a fuel discharger;
a fuel processing unit adapted to generate hydrogen from the fuel and adapted to supply the hydrogen to the electricity generator;
a fuel supply unit adapted to supply a predetermined amount of fuel to the fuel processing unit;
an oxygen supply unit adapted to supply oxygen to the electricity generator;
a valve unit connected to the fuel discharger of the electricity generator and adapted to adjust a fuel pressure in the electricity generator;
a sensor unit disposed in the electricity generator and adapted to sense an output amount of electricity of the electricity generator; and
a control unit adapted to convert a sensed signal from the sensor unit into a predetermined control signal and adapted to control the valve unit with the predetermined control signal.

28. The fuel cell system of claim 27, wherein the fuel supply unit comprises a cylinder part forming a closed space and a fuel storage part disposed in the cylinder part.

29. The fuel cell system of claim 28, wherein the fuel storage part comprises a flexible shape structure.

30. The fuel cell system of claim 28, wherein the fuel supply unit comprises a bias part connected to the cylinder part and wherein the bias part supplies a compressed gas to the cylinder part to substantially compress the fuel storage part.

31. The fuel cell system of claim 30, wherein the bias part comprises a compressed gas supply member adapted to inject the compressed gas into the cylinder part.

32. The fuel cell system of claim 28, wherein the fuel supply unit comprises a bias part connected to the cylinder part and the fuel storage part and wherein the bias part compresses the fuel storage part with a predetermined elastic force.

33. The fuel cell system of claim 32, wherein the bias part comprises an elastic member disposed in the cylinder part and connected to the fuel storage part.

34. The fuel cell system of claim 27, further comprising a valve disposed in a fuel supply path connecting the fuel supply unit to the fuel processing unit and adapted to selectively open and shut the fuel supply path.
